(19) United States
(12) Patent Application Publication
(10) Pub. No.: US 2016/0176589 A1
(43) Pub. Date: Jun. 23, 2016

(54) COMBINATION BOTTLE CLOSURE, POUR SPOUT, AND WINE AERATOR

(71) Applicant: Walter J. Averill, Windsor, CA (US)

(72) Inventor: Walter J. Averill, Windsor, CA (US)

(21) Appl. No.: 14/582,024

(22) Filed: Dec. 23, 2014

(51) Int. Cl. B65D 47/06; B01F 5/04; B01F 3/04

(52) U.S. Cl. CPC B65D 47/066; B01F 3/04794; B01F 5/0403; B01F 2215/0072

(57) ABSTRACT

A bottle closure having an open configuration and a closed configuration, the bottle closure including a resilient cap, a resilient cylindrical sleeve disposed below said cap; an elastic pour spout disposed atop said cap, said pour spout bendable into a kinked closed configuration; and a fastener to hold said pour spout in the closed configuration; wherein said cap includes an opening into said sleeve, and said sleeve and said pour spout define a continuous through hole when said bottle closure is in an open configuration.

### CROSS REFERENCES TO RELATED APPLICATIONS

Not applicable. The present application is an original and first-filed United States Utility patent application.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### SEQUENCE LISTING

Not applicable.

### BACKGROUND OF THE INVENTION

### Field of the Invention

The present invention relates to bottle closures, and more particularly to secondary wine bottle closures, and still more particularly to a combination bottle closure, pour spout, and wine aerator.

### SUMMARY OF THE INVENTION

The present invention is multipurpose combination bottle closure, pour spout, and wine aeration apparatus having an open configuration and a closed configuration. The bottle closure includes a resilient cap, a resilient cylindrical sleeve disposed below the cap, an elastic pour spout disposed atop the cap, wherein the pour spout can be bent into a kinked closed configuration, and a fastener to hold the pour spout in the closed configuration. The cap includes an opening into the sleeve, and the sleeve and the pour spout define a continuous through hole when the bottle closure is in an open configuration. Accordingly, a user may place the inventive apparatus onto an opened bottle of wine and either selectively bend the pour spout and secure it with a fastener to “close” the bottle so as to prevent further oxidation or selectively open release the fastener to open the bottle closure and allow wine to be poured through the spout. At least a portion of the spout includes interior surface features that introduce turbulence into wine poured from the bottle so as to facilitate aeration.

It is a first and principal object of the present invention to provide a bottle closure for an open bottle of wine.

It is a further object of the present invention to provide a pour spout for a bottle of wine.

Yet another object of the present invention is to provide an improved wine aerator incorporated into a pour spout.

Still another object of the present invention is to provide a bottle closure that is combined with a pour spout and a wine aerator.

A still further object of the present invention is to provide a combination bottle closure, pour spout, and wine aerator that provides a user with the option to pour a wine through either an aerating side of the pour spout or a non-aerating side of the pour spout.

Yet another object of the present invention is to provide a combination bottle closure, pour spout, and wine aerator that enables a user to both close and pour from a wine bottle without having to remove a stopper apparatus.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which form the subject matter of the claims set out herein.

### BRIEF DESCRIPTION OF THE SEVERAL VIEWS OF THE DRAWINGS

The invention will be best understood and objects other than those set forth above will become apparent when consideration is given to the following detailed description thereof. Such description makes reference to the annexed drawings wherein:

FIG. 1 is an upper front right perspective view showing the inventive combination bottle closure, pour spout, and wine aerator installed on a wine bottle;

FIG. 1B is an upper front right perspective view showing the inventive device in the open configuration;

FIG. 1C is the same view showing the device in the closed configuration;

FIG. 2A is a front view in elevation of the bottle closure, pour spout, and wine aerator shown in the open configuration;

FIG. 2B is a left side view in elevation thereof;

FIG. 2C is a top plan view thereof;

FIG. 2D is a bottom plan view thereof;

FIG. 3A is a cross-sectional left side view in elevation taken along section line 3A-3A of FIG. 2A; and

FIG. 3B is a cross-sectional side view in elevation showing the device in the closed configuration.

### DETAILED DESCRIPTION OF THE INVENTION

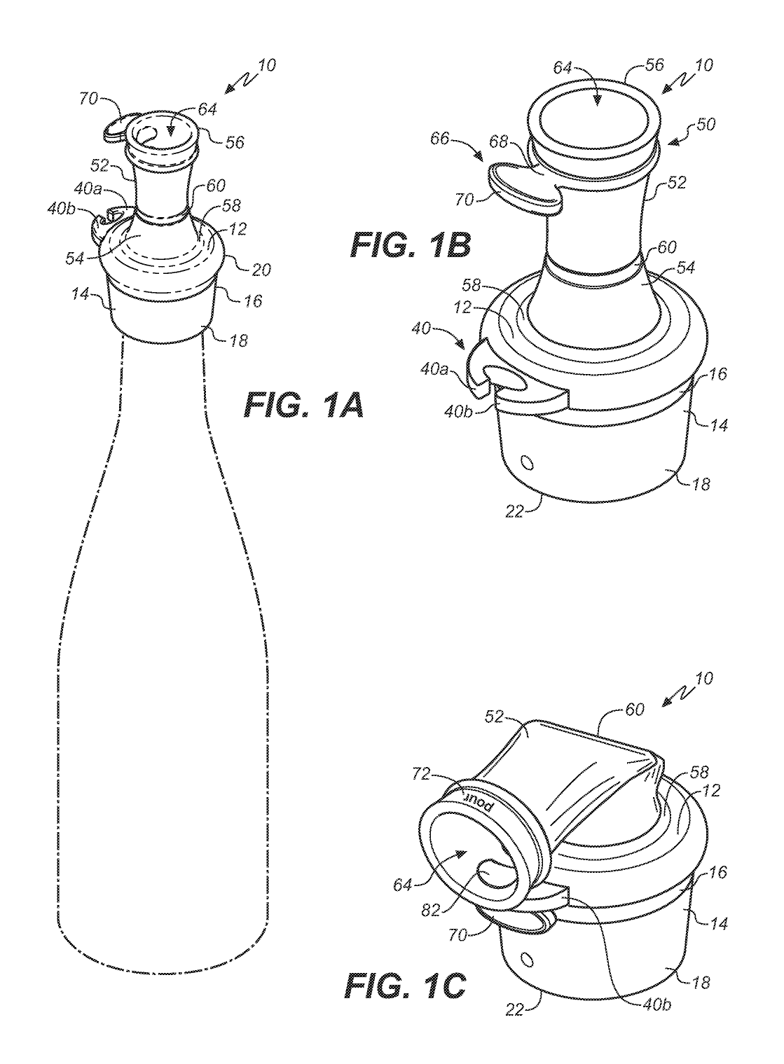

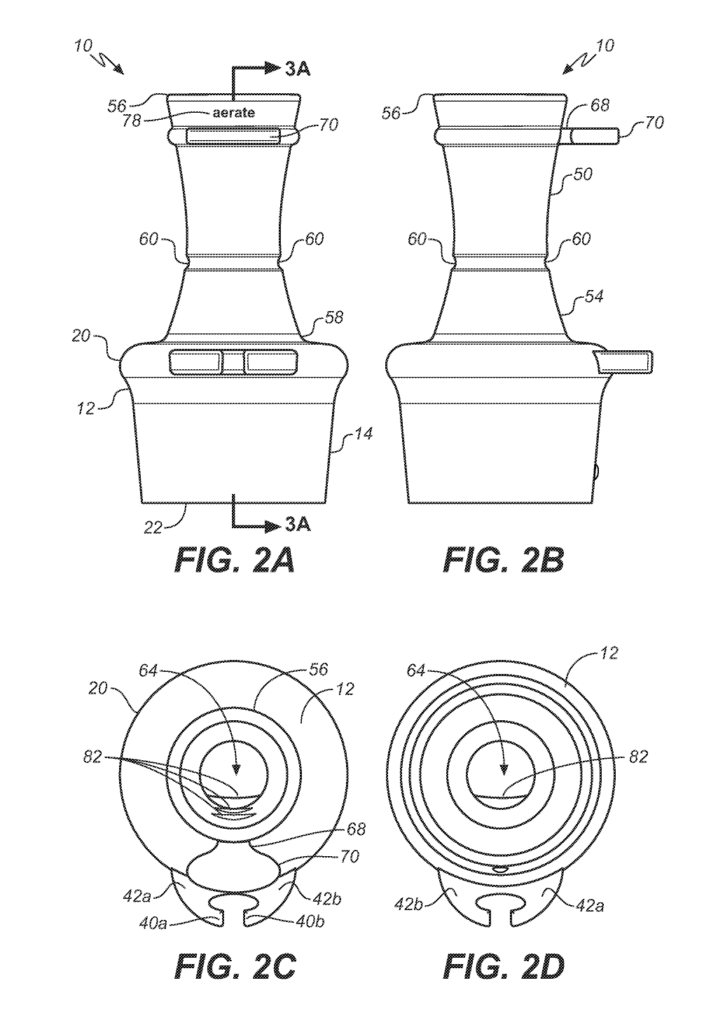

Referring to FIGS. 1 through 3B, wherein like reference numerals refer to like components in the various views, there is illustrated therein a novel combination bottle closure, pour spout, and wine aerator, generally denominated 10 herein and summarily referred to herein as a multipurpose closure apparatus.

In a preferred embodiment, the multipurpose closure apparatus of the present invention includes a cap portion 12 disposed above a slightly tapered resilient and elastic cylindrical sleeve 14 having a medial portion 16 which tightly circumscribes the upper banded collar or top flange of a wine bottle, and a lower sleeve portion 18 which tightly circumscribes the bottle neck immediately below the banded collar. As will be appreciated, the cap is placed over the open mouth of an open wine bottle. The cap portion preferably includes an enlarged rim 20 forming a prominent ridge above the cylindrical sleeve 14 to facilitate gripping by a user. When installed on a wine bottle, the cap portion circumscribes the bottle neck around the banded collar finish characteristic of wine bottles, which is the upper pouring spout immediately above the top flange of the bottle.

From the expanded cap portion rim 20 to the bottom edge 22 of the lower sleeve portion 18, the cylindrical sleeve 14 of the capsule preferably tapers gently inward.

The cap portion interior 24 has an opening 25 at its top such that it does not, itself, provide a bottle closure that prevents fluid from being poured from a bottle. A complete closure requires a bending of the pour spout. The cap portion and sleeve define an interior divided into three distinct portions, including an upper portion 26, a medial portion 28, and a lower portion 30, each defined by the surface configuration of the interior wall 32 of the capsule. The interior wall thus includes a generally cylindrical lower portion 34 having a first diameter that defines the lower sleeve portion; an annular medial channel 36 has a second diameter larger than the first diameter and defines the medial portion that accommodates the bottle top flange; and a small upper cylindrical portion 38, having a third diameter approximately the same as that of the first diameter, that defines the upper portion and closely surrounds and engages the uppermost portion of the bottle, namely the pouring spout of the bottle.

A first clasp (or clip) element 40 is integrally formed with the cap portion expanded rim and projects outwardly from the rim generally normal to the longitudinal axis 42 of the entire apparatus. This feature is preferably a female clasp feature that comprises two inwardly curving fingers 40a, 40b gapped at their tips so as to accommodate a complementary male clasp element (described below). The cap portion is preferably fabricated from Shore A40 food grade silicone.

The multipurpose closure next includes an hourglass-shaped hollow pour spout 50 extending upwardly and outwardly from the cap portion and having an inwardly tapering upper portion 52 that terminates in an upper end edge 56 and an outwardly tapering lower portion 54 that terminates at its lower edge 58 at an integral connection with the cap portion 12. An annular groove 60 circumscribes (or rings) the outer side of the pour spout and divides the pour spout upper portion 52 from the lower portion 54. Interiorly, the pour spout is open at its bottom end 56 such that it shares and is continuous with the opening 62 in the cap portion and such that the openings through the cap and the pour spout form a continuous opening 64 from the bottom edge 22 of the cylindrical sleeve to the upper edge 56 of the pour spout 50.

The pour spout next includes a second clasp element 66, complementary to said first clasp element, the second clasp element preferably comprising a male feature that includes an outwardly projecting shaft 68 and finger tab 70. Preferably, the pour spout is fabricated from a softer Shore A30 food grade silicone, and the annular groove and relatively soft, resilient material ensure that the spout can be folded at the groove so as to bring the male clasp element into alignment for insertion of the shaft 68 into the female clasp gap, where it is captured and prevented from release by engagement of the sizable finger tab with the female clasp. It is in this way that the multipurpose closure apparatus effects a bottle closure. When the pour spout is bent over at the annular groove and the male clasp element captured by the female clasp element, the pour spout is “kinked” and prevents liquid from being poured from the bottle, much as a kinked hose prevents the discharge of water from the end of the hose. Of course, the differential in Shore hardness could begin only slightly below the annular groove, inasmuch as it is the groove and a part of the outwardly tapering lower portion that create the kink in the spout. Further, the multipurpose closure apparatus could be fabricated from a single material, the only essential feature being that the pour spout must be capable of being bent into a closed configuration, retained in the bent configuration using the clasp elements, and that the pour spout readily and rapidly returns to an open (un-bent) configuration when the clasp is unlocked or released. The nature and strength of the clasp therefore informs some of the material properties of the pour spout, specifically with respect to elastic deformation properties of modulus and elastic limit.

The exterior portion of the pour spout includes markings to indicate two distinct functions of the pour spout: a first marking—viz., “pour” 72—on the pour spout exterior 74 corresponding to approximately half of the concave interior side 76 of the pour spout which has a smooth surface; and a second marking—“aerate” 78—corresponding, again, to an approximately one half of the concave interior side of the pour spout, but in this instance corresponding to a contoured interior surface 80, wherein the surface is provided with features 82 such as paddles, baffles, and/or small weirs or other small surface irregularities that introduce turbulence in wine as it flows over the interior surface of this half of the pour spout. The surface features may be identically sized or provided in varying dimensions as optimal for creating high levels of turbulence. The turbulence exposes an increased volume of the wine to atmospheric oxygen for a more rapid aeration than can be accomplished simply by pouring the wine directly into a glass. While the location of the markings is essentially arbitrary, as they could be positioned in an opposing relationship (180 degree separation) anywhere around the upper or lower portions of the pour spout, it is mnemonically advantageous to locate the “aerate” marking at the clasp element because it corresponds with corresponding internal surface structure (the aeration elements) in the pour spout.

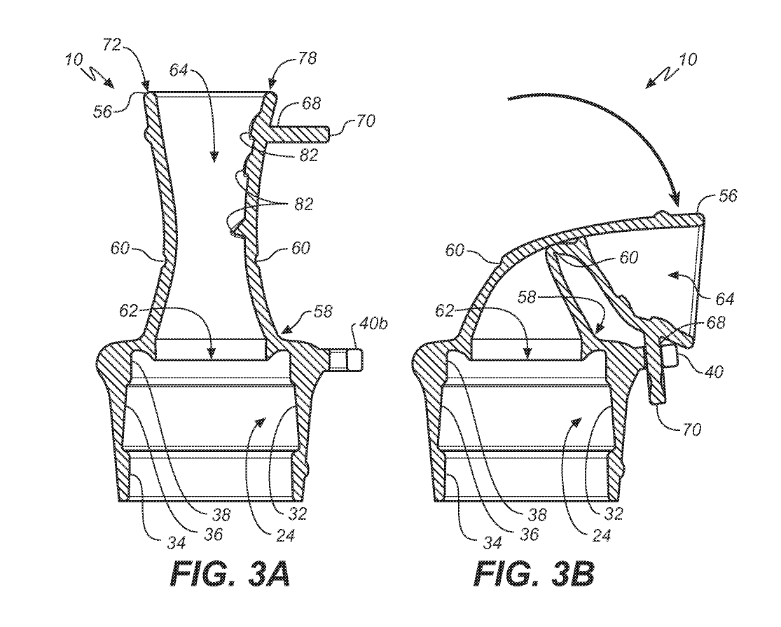

FIG. 3A, a cross-sectional side view in elevation, shows the above-described interior surface features of the aeration portion of the pour spout. It will be appreciated, however, that the particular elements selected for producing fluid turbulence are only one of myriad forms that could accomplish the same ends. Thus, it will be understood that there is nothing limiting in the recitation of baffles or weirs or other known elements. Alternative forms could include various kinds of regular and irregular convexities or protuberances, such as points, ridges, teeth, corrugations, bumps, ridges, and so forth.

Looking now at FIG. 3B, advantageously, when a bottle of wine is opened and not consumed in its entirety, the pour spout may simply be bent at the groove 60 and the male and female clasp elements employed to secure the pour spout in a “kinked” configuration, thus preventing more air from coming into contact with wine and preventing wine from being poured from the bottle. To resume use, the male clasp element is merely pulled out and away from the female clasp element, and the resilient silicone rubber pour spout will resume its upright orientation with an unobstructed central opening 64. At that point, the user may again choose whether to pour the wine out through the aerating side of the spout or the non-aerating side, depending on the desired effect of slightly more rapid oxidation.

As will be appreciated from the foregoing, the inventive multipurpose combination bottle closure, pour spout, and wine aerator of the present invention is, most essentially, a cap portion with a selectively aerating spout that may be bent and secured in a bent configuration for wine storage.

What is claimed as invention is:

1. A combination bottle closure, pour spout, and wine aerator apparatus, comprising:
a cap portion configured to fit over the open mouth of a wine bottle and having an opening;
an elastic cylindrical sleeve disposed below said cap portion for securing around the cylindrical neck of a bottle below the rim of the bottle;
a resilient hollow pour spout extending upwardly and outwardly from said cap portion so as to form a continuous opening through said cap portion, said cylindrical sleeve, and said pour spout;
clasp elements on at least said pour spout, such that said pour spout may be bent into a closed configuration by forming a kink in said pour spout and may be selectively and releasably retained by said clasp elements in said closed configuration so as to prevent fluid from being poured from the bottle.

2. The apparatus of claim 1, wherein said sleeve is tapered inwardly from an upper rim to a lower edge.

3. The apparatus of claim 1, wherein said sleeve includes a medial portion configured to fit around the upper banded collar of a wine bottle, and a lower sleeve portion configured to tightly circumscribe the wine bottle neck immediately below the banded collar.

4. The apparatus of claim 1, wherein said cap portion includes an enlarged rim forming a prominent ridge above said sleeve to facilitate gripping by a user.

5. The apparatus of claim 1, wherein said pour spout includes an inwardly tapering upper portion that terminates in an upper end edge and an outwardly tapering lower portion that terminates at its lower edge in said cap portion.

6. The apparatus of claim 5, further including an annular groove between said upper and said lower portion of said pour spout.

7. The apparatus of claim 6, wherein said annular groove circumscribes the outer side of said pour spout dividing said pour spout into said upper portion and said lower portion.

8. The apparatus of claim 6, wherein said cap portion has an opening into said pour spout and said pour spout is open at its bottom end such that it shares and is continuous with said opening in said cap portion such that the openings through said cap portion and said pour spout form a continuous opening from said bottom edge of said sleeve to said upper edge of said pour spout.

9. The apparatus of claim 1, wherein said cap portion and said cylindrical sleeve define an interior divided into a cylindrical lower portion having a first diameter, an annular medial channel having a second diameter larger than said first diameter, and an upper cylindrical portion having a third diameter approximately the same as that of said first diameter.

10. The apparatus of claim 1, wherein said clasp elements include a first clasp element connected to said cap portion and a complementary second clasp element connected to said cap portion.

11. The apparatus of claim 10, wherein said first and second clasp elements include a female clasp element and a male clasp element including an elongate portion that inserts into said female clasp element to secure said pour spout in a closed configuration.

12. The apparatus of claim 11, wherein said female clasp comprises two inwardly curving fingers having a gap between their tips so as to accommodate said elongate portion of said male clasp element.

13. The apparatus of claim 1, wherein said hollow pour spout includes an aerating portion and a non-aerating portion.

14. The apparatus of claim 13, wherein said aerating portion including a contoured interior surface having features that introduce turbulence in wine as it flows over said interior surface.

15. A bottle stopper, pour spout, and aerator for an open bottle of wine, comprising:
a cap portion having an opening;
a cylindrical sleeve configured for placement over the open mouth of a wine bottle to encircle the neck of the wine bottle and to hold said cap portion firmly in contact with the upper rim of the wine bottle;
a flexible pour spout having an open configuration and a closed configuration and an interior having an aerator portion;
a fastener;
wherein said flexible pour spout is bent to achieve the closed configuration to prevent wine from being poured from the wine bottle and said fastening apparatus selectively holds said pour spout in said closed configuration.

16. The bottle stopper, pour spout, and aerator of claim 15, wherein said aerator portion of said pour spout comprise surface features on the interior surface of said pour spout that introduce turbulence in wine poured over said surface features.

17. The bottle stopper, pour spout, and aerator of claim 15, wherein said pour spout has an hourglass shape, taping inwardly from an upper rim to a medial portion and tapering outwardly from said medial portion to said cap portion.

18. A bottle closure having an open configuration and a closed configuration, comprising:
a resilient cap;
a resilient cylindrical sleeve disposed below said cap;
an elastic pour spout disposed atop said cap, said pour spout bendable into a kinked closed configuration; and
a fastener to hold said pour spout in the closed configuration;
wherein said cap includes an opening into said sleeve, and said sleeve and said pour spout define a continuous through hole when said bottle closure is in an open configuration.

19. The bottle closure of claim 18, wherein said pour spout includes surface features on at least a portion of its interior side for producing fluid turbulence in wine poured through said pour spout.

20. The bottle closure of claim 18, wherein said pour spout includes a furrow to facilitate bending into the closed configuration.
